(19) United States
(12) Patent Application Publication
(10) Pub. No.: US 2022/0210830 A1
(43) Pub. Date: Jun. 30, 2022

(54) METHODS FOR CHANNEL ACCESS PROCEDURE SWITCHING

(71) Applicant: GUANGDONG OPPO MOBILE TELECOMMUNICATIONS CORP., LTD., Dongguan (CN)

(72) Inventor: Hao LIN, Neuilly-sur-Seine (FR)

(21) Appl. No.: 17/693,546

(22) Filed: Mar. 14, 2022

Related U.S. Application Data
(63) Continuation of application No. PCT/CN2020/129453, filed on Nov. 17, 2020.
(60) Provisional application No. 62/936,599, filed on Nov. 17, 2019.

(51) Int. Cl. H04W 74/08; H04W 16/14

(52) U.S. Cl. CPC H04W 74/0808; H04W 16/14

(57) ABSTRACT

According to an embodiment of the present disclosure, there is provided a method for performing channel access procedure, in a communication system including a terminal, UE, and a base station, BS, communicating in a shared spectrum. The method including the following two steps of sending, by a BS to a UE, a first information including information indicative of channel occupancy time, COT, of the BS and performing, by the UE, channel access procedure of a first type or channel access procedure of a second type, based on at least the first information, to perform an uplink transmission.

### CROSS-REFERENCE TO RELATED APPLICATION

The present application is a continuation application of International Application No. PCT/CN2020/129453, filed on Nov. 17, 2020, which claims the priority of U.S. provisional application 62/936,599, filed on Nov. 17, 2019. The present application claims priority and the benefit of the above-identified applications and the above-identified applications are incorporated by reference herein in their entireties.

### TECHNICAL FIELD

The present disclosure relates to a terminal and radio communication method in the next generation mobile communication system. More specifically the present disclosure relates to the field of communication in the shared spectrum using channel access procedures. It particularly relates to method and devices performing a channel access procedure switching in a next generation communication system.

### BACKGROUND

Originally, LTE was designed for licensed spectrum where an operator may have an exclusive license for a certain frequency range. A licensed spectrum offers benefits since the operator may plan the network and control interference situations. However, there is usually a cost associated with obtaining a license for the spectrum and the amount of licensed spectrum is also typically limited.

On the other hand, the unlicensed spectrum is a shared spectrum which can be used by communication devices in different communication systems without having to obtain a spectrum license or an authorization from a government or from a license body. A characteristic of the shared spectrum is that it can typically be used at no cost, subject to a device meeting regulatory requirements.

These requirements are set by the country or region on the shared spectrum and are conceived to allow various communication systems using the shared spectrum to coexist friendly in the spectrum.

One requirement may be the implementation of a channel access procedure, for instance a Listen-Before-Talk, LBT procedure. A channel access procedure is a procedure based on sensing that evaluates the availability of a channel for performing transmissions. According to the LBT procedure the device needs to perform channel sensing before transmitting the signal on the channel. Only when the LBT outcome shows that the channel can be used for transmitting the signal (for instance when the channel is idle, i.e. there is no transmission occurring on the channel) the device can perform signal transmission. Otherwise, the device cannot perform signal transmission. Using the LBT the communication device may acquire (or obtain) a Channel Occupancy Time, COT. The COT may define a continuous time interval for which the communication device can perform transmission using the channel.

One of the characteristics of operations in a shared spectrum is a fair sharing of the spectrum with other operators and other systems, as for example Wi-Fi. In order to ensure such a fairness, once a device successfully occupies the channel, the transmission duration cannot exceed a Maximum Channel Occupancy Time, MCOT.

One important feature of the 5G wireless access technology, also known as new radio, NR, is a substantial expansion in terms of the range of spectra in which the radio-access technology can be deployed. Unlike LTE, where support for licensed spectra at, for example, 3.5 GHz and shared spectra at, for example, 5 GHz are introduced, NR supports licensed-spectrum operation from below 1 GHz up to 52.6 GHz already from the first release, and extensions to shared spectra are also planned. For instance, some of the higher frequency bands which NR is likely to address are unlicensed (or shared).

There are four categories of LBT procedure which can be referred to as category 1, or Cat1, category 2, or Cat2, category 3, or Cat3 and category 4, or Cat4. These categories are also described in TR 38.889 section 8.2. In particular:

Category 1 (Cat 1): Immediate transmission after a short switching gap.

This is used for a transmitter to immediately transmit after a switching gap inside a COT.

The switching gap from reception to transmission is to accommodate the transceiver turnaround time and is no longer than 16 μs.

Category 2 (Cat 2): LBT without random back-off.

The duration of time that the channel is sensed to be idle before the transmitting entity transmits is deterministic.

Category 3: LBT with random back-off with a contention window of fixed size.

The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.

Category 4 (Cat 4): LBT with random back-off with a contention window of variable size.

The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel

### SUMMARY

On the shared carrier, the base station may share the channel occupancy time, COT, with the UE. This COT may then be used by the UE for performing uplink transmission. The UE may hence adapt the channel access procedure (for instance the LBT procedure) based on the base station's COT. However, the channel access procedure type (for instance the LBT category) adaptation design is still an open problem.

One object of the present disclosure is to at least partially address the shortcoming of the prior art and the present disclosure relates to a method to perform channel access procedure and particularly to realize channel access procedure type adaptation.

The present disclosure has the advantageous effect that the channel access procedure type can be adapted, or switched, based on the COT of the gNB and hence channel access procedure performance can be increased, and communication efficiency can thus be increased.

### Solution to the Problem

According to an implementation of the present disclosure, there is provided a method for performing channel access procedure, in a communication system comprising a terminal, UE, and a base station, BS, communicating in a shared spectrum. The method comprising the following two steps of sending, by a BS to a UE, a first information including information indicative of channel occupancy time, COT, of the BS and performing, by the UE, channel access procedure of a first type or channel access procedure of a second type, based on at least the first information, to perform an uplink transmission.

According to a sub-implementation of the present disclosure there is provided a method for performing channel access procedure wherein the UE receives the first information before performing the uplink transmission.

According to another sub-implementation of the present disclosure there is provided a method for performing channel access procedure wherein the channel access procedure of the second type is determined for the uplink transmission before receiving the first information.

According to another sub-implementation of the present disclosure the UE receives a DCI format 2_0 from the BS, wherein the DCI format 2_0 comprises the first information.

According to another sub-implementation of the present disclosure the first information comprises a channel occupancy duration.

According to another sub-implementation of the present disclosure the UE determines a channel occupancy end from the channel occupancy duration and a location of the DCI format 2_0.

According to another sub-implementation of the present disclosure the UE performs the first type channel access procedure when the uplink transmission is within the channel occupancy duration.

According to another sub-implementation of the present disclosure the first type channel access procedure comprises at least a type 2A channel access procedure.

According to another sub-implementation of the present disclosure the type 2A channel access procedure comprises a deterministic sensing duration of 25 microseconds (μs).

According to another sub-implementation of the present disclosure the second type channel access procedure comprises at least a type 1 channel access procedure.

According to another sub-implementation of the present disclosure the type 1 channel access procedure comprises a random sensing duration, wherein the random sensing duration is relevant to a channel access priority class.

According to another sub-implementation of the present disclosure the UE performs the second type channel access procedure when the uplink transmission is not within the channel occupancy duration.

According to another sub-implementation of the present disclosure the uplink transmission comprises at least one of the followings: PUSCH transmission, PUCCH transmission, SRS transmission, PRACH transmission.

According to another sub-implementation of the present disclosure the UE receives a second DCI format before the DCI format 2_0, wherein the uplink transmission is scheduled by a second DCI format, wherein the second DCI format comprises at least one of the followings: DCI format 1_0, DCI format 1_1, DCI format 1_2, DCI format.

### BRIEF DESCRIPTION OF THE DRAWINGS

FIG. 1 schematically shows a block diagram of a method corresponding to a first implementation of the present disclosure.

FIG. 2 schematically illustrates a channel access procedure according to the first implementation.

FIG. 3A schematically shows a block diagram of a method corresponding to a sub-implementation of the first implementation.

FIG. 3B schematically show a block diagram of a method corresponding to a sub-implementation of the first implementation.

FIG. 4 schematically illustrates channel access procedure settings of a channel access procedure scheme according to a second implementation of the present disclosure.

FIG. 5 schematically illustrates channel access procedure settings of a channel access procedure scheme according to a second implementation of the present disclosure.

FIG. 6 schematically illustrates different channel access procedure settings of a channel access procedure scheme according to the second implementation of the present disclosure.

FIG. 7 schematically illustrates a configuration of a base station suitable for carrying out the present disclosure.

FIG. 8 schematically illustrates a configuration of a terminal suitable for carrying out the present disclosure.

FIG. 9 shows an example of a wireless communication network.

### DETAILED DESCRIPTION

The present disclosure is described below in conjunction with specific implementations and examples. These detailed implementations and specific examples serve merely to provide the person skilled in the art with a better understanding of the disclosure but are not intended to in any way restrict the scope of the disclosure, which is defined by appended claims. Moreover, as it will be apparent to the skilled person, implementations described independently throughout the description may be combined to form further implementations to the extent that said implementations are not mutually exclusive.

Further moreover, also in view of the relationship between type and category, in the following the terms “type” and “category” may be used interchangeably unless indicated otherwise. Similarly, for instance, the terms “channel access procedure type” and “LBT type” may be used also interchangeably unless indicated otherwise. Furthermore, unless indicated otherwise, the terms “channel access procedure” and “LBT” may also be used as synonyms.

In particular, LBT Cat 4 is also known as type 1 channel access. This channel access type is described in TS 37.213 section 4.2.1.1 of the standard which is also reported below.

LBT Cat 2 is equivalent to type 2A or to type 2B channel access. This channel access type is described in TS 37.213 section 4.2.1.2 of the standard which is also reported below. There can be two sensing duration defined for LBT Cat 2. For instance, LBT Cat 2 with 25 μs (type 2A) and LBT Cat 2 with 16 μs (type 2B), where 25 μs (or μs) and 16 μs are two sensing duration. These sensing durations are also referred to as gap in the following disclosure.

Finally, LBT Cat 1 is equivalent to type 2C channel access also described in TS 37.213 section 4.2.1.2 of the standard.

In the shared spectrum the base station, BS, (which is also referred to as gNB in 5G) may obtain a COT. This COT may be shared by the base station with user terminals, UEs or with a UE. Here a user terminal, user equipment or UE, is an example of a terminal. The shared COT may then be used by the UE for performing uplink transmission. For instance, for transmitting the uplink signal or the uplink channel. In other words, when the BS shares its own channel occupancy time with the UE, the UE can use the LBT mode with priority higher than the priority the UE has when the UE performs LBT itself to obtain the channel For instance, the UE can change the LBT type or the LBT category. Moreover, the UE can use different priority classes as explained below. Hence when the base station shares its own channel occupancy time with the UE, the UE obtains the channel with greater probability.

According to the present disclosure, in the case of LBT procedure, when the gNB schedules a Physical Uplink Shared Channel, PUSCH, or pre-configures PUSCH resources, the PUSCH resources scheduled to the UE might not be within the gNB's COT. In this case, the gNB may indicate LBT Cat4, to the UE and the UE may perform transmission using LBT Cat4. However, after the scheduling, the gNB may obtain a new COT which may take place before the scheduled or pre-configured PUSCH occurs in the time domain and may end thereafter. In this case the gNB may share the COT with the UE, then the UE might be able to adapt its LBT category, for instance, from Cat 4 to Cat 2, or to Cat 1. In other words, the gNB may initially schedule a UE to transmit a PUSCH by performing LBT Cat4 (that is, a channel access procedure type 1) if the resources in the time domain allocated to the PUSCH are not comprised in the gNB's COT (or if the gNB's COT is not shared with the UE). Subsequently, the gNB may obtain a COT and may send a first information to the UE indicating the obtained COT. Based on the first information the UE may then transmit the PUSCH by performing LBT Cat 1 or LBT Cat 2 (that is a channel access procedure of type 2A or type 2B or type 2C) if the resources in the time domain allocated to the PUSCH are before the gNB's COT end in the time domain. Here a PUSCH transmission is an example of uplink transmission Channel access procedure type 2A or channel access procedure type 2B (or LBT Cat 2) and channel access procedure type 2C (or LBT Cat 1), may be also referred to as channel access procedure of the first type. Moreover, channel access procedure type 1 (or LBT Cat4) may also be referred to as channel access procedure of a second type.

[First Implementation]

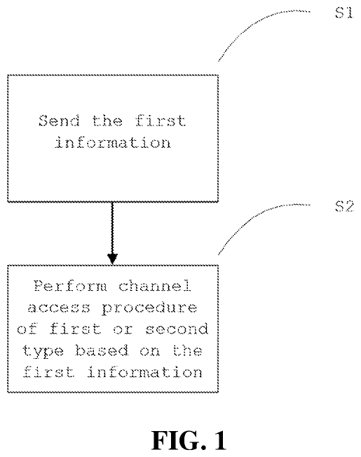

According to a first implementation of the present disclosure, as schematically illustrated in FIG. 1, there is provided a method for performing a channel access procedure comprising the step S1 of sending, by the gNB, to the UE, the first information including information indicative of COT, of the gNB. The method of the first implementation also comprises the step S2 of performing, by the UE, channel access procedure of a first type or channel access procedure of a second type based on the first information to transmit an uplink signal or an uplink channel The channel access procedure may exemplarily be an LBT procedure.

The first information sent by the gNB may for instance be comprised in a downlink control information, DCI, for instance DCI format 2_0 (or DCI 2_0), which may be included in a Physical Downlink Control Channel, PDCCH. The PDCCH may be a group-common PDCCH. The first information may include information indicative of channel occupancy time, COT, of the gNB. Preferably, the first information may be indicative of, or comprise, a channel occupancy duration. A starting time of the channel occupancy duration may for instance be implicitly determined based on the first symbol of the slot in which the UE receives the DCI indicating the channel occupancy duration. The UE may also for instance determine a channel occupancy end from the channel occupancy start and channel occupancy duration. That is, according to a sub-implementation the UE may determine a channel occupancy end based on the channel occupancy duration and a location of the DCI format 2_0. The location may for instance be the first symbol of the slot in which the UE receives the DCI.

However, configurations different from the above described preferred configuration are also possible. For instance, the first information may indicate the starting time and the ending time of the channel occupancy. The first information may also indicate a starting time and a duration of the channel occupancy or may indicate an ending time and a duration of the channel occupancy. Alternatively, the first information may only indicate the ending time of the channel occupancy.

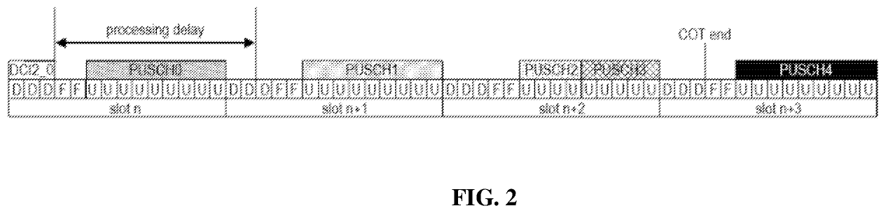

FIG. 2 shows a channel access procedure upon detection of common DCI according to the first implementation. It is assumed for ease of explanation that several PUSCHs are scheduled. For instance, PUSCH0 to PUSCH4 are scheduled (or are pre-configured) by the gNB. It is also assumed that the different PUSCH are scheduled to different UEs, for instance to UEs UE0 to UE4 (for the sake of simplicity not shown in the figures). It is however to be understood that these assumptions are only for the sake of illustration and do not represent a limitation of the present disclosure.

FIG. 2 exemplarily shows that PUSCH0 to PUSCH4 are scheduled respectively for slot n, slot n+1, slot n+2 and for slot n+3 and the DCI format 2_0 is received in the slot n. It also shows that the UE1 to UE4 receive the DCI format 2_0, i.e. the first information, before performing the uplink transmission, i.e. PUSCH1 to PUSCH4.

According to the method for performing LBT of the first implementation, the UEs may receive group-common control channel, i.e. a group common PDCCH. The control channel may carry a slot format indicator, SFI. The SFI may for instance provide information regarding a symbol type of symbols included in the slot. The symbol type may indicate that a symbol is a downlink, D, symbol, that it is an uplink, U, symbol or that it is a flexible, F symbol. In the example shown in FIG. 2 each slot has illustratively three downlink symbols, two flexible symbols and nine uplink symbols. However, the present disclosure is not limited thereto.

The control channel may also carry information about the COT duration. In view of the COT information, the UE can know when the COT will end. That is, for instance, based on the COT information, the UE can determine, derive, or establish a COT ending point and/or a COT starting point.

When the gNB schedules the PUSCHs PUSCH0 to PUSCH4, the gNB indicates an LBT of a given category (or a channel access procedure of a given type) to all of them. For instance, according to a sub implementation, gNB may sent to all the UEs a second DCI format before the DCI format 2_0. The UE may receive the second DCI format before the DCI format 2_0 and the uplink transmission may be scheduled by the second DCI format. Moreover, the second DCI format may for instance comprise at least one of the followings: DCI format 1_0, DCI format 1_1, DCI format 1_2, DCI format. The gNB may for instance indicate Cat4 to all the UEs. That is, according to a sub-implementation, the channel access procedure of the second type (Cat 4, type 1) is determined for the uplink transmission (PUSCH0 to PUSCH4) before receiving the first information (DCI format 2_0).

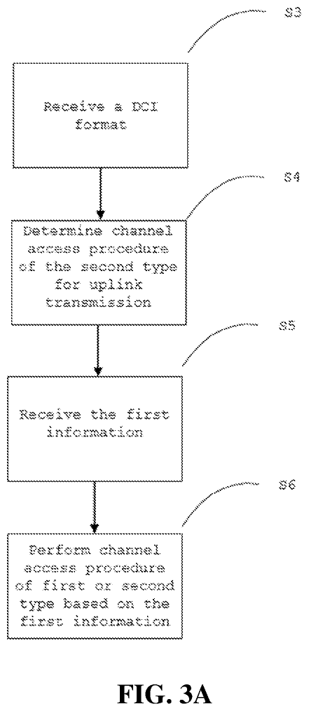

In other words, and as shown in FIG. 3A, the UE may firstly receive a DCI format, i.e. the second DCI format (S3), and it may determine the channel access procedure of the second type for uplink transmission (S4) before receiving the first information (S5). The UE may subsequently perform the channel access procedure of the first type or the channel access procedure of the second type based on the first information (S6).

After the scheduling by the gNB and before the scheduled PUSCH resource in time domain occurs, the UEs may receive a group-common PDCCH, e.g. the DCI format 2_0 in a time slot, for instance in slot n. The DCI format 2_0 includes at least information indicative of channel occupancy time, COT. Moreover, the DCI format 2_0, may also include or provide indication for several additional information, as for instance for one or more of the SFI, the COT duration (or the channel occupancy duration) and a gNB COT sharing indication.

The SFI gives, i.e. indicates, the symbol type for each of the symbols for all the slots within DCI format 2_0 monitoring period. For instance, the DCI format 2_0 indicates to the UE the slot format for each slot in a number of slots starting from a slot where the UE detects the DCI format 2_0. The number of slots may be equal to or larger than the PDCCH monitoring period for DCI format 2_0. The COT duration provides information regarding the duration of the COT, for instance it lets the UE know when the end of the COT is. That is, it provides information indicative of the end of the COT. FIG. 2 shows illustratively a case wherein the COT duration information field in the DCI format 2_0 indicates that the COT will end after the 3^{rd} symbol of slot n+3. With reference to FIG. 3B and according to a sub-implementation of the first implementation, the UE may receive the first information (S7) and may determine whether the uplink transmission is within the channel occupancy duration (S8). The UE may perform the first type channel access procedure when the uplink transmission is within the channel occupancy duration (S9). Moreover, the UE may perform the second type channel access procedure when the uplink transmission is not within the channel occupancy duration (S10).

In other words, in the example given, the first type channel access procedure may be performed for uplink transmission scheduled before the end of the COT which is after the 3^{rd} symbol of slot n+3. Moreover, the second type channel access procedure may be performed for uplink transmission which are scheduled after the 3^{rd} symbol of slot n+3.

Preferably, the first type channel access procedure comprises at least a type 2A channel access procedure. The second type channel access procedure comprises at least a type 1 channel access procedure. Moreover, according to a sub-implementation of the first implementation the type 2A channel access procedure comprises a deterministic sensing duration of 25 ₕis.

The gNB COT sharing indication is an information indicating to the UEs whether or not a given gNB's COT can be shared with UEs to transmit the scheduled PUSCH in the gNB's COT. That is, the gNB COT sharing indication indicates whether the COT is shared or is not shared by the gNB with the UEs.

If the gNB COT is allowed to be shared, i.e. if the gNB's COT is shareable with the UEs, the UE may perform channel access procedure type switching or LBT category (or type) switching. In particular, the UE may switch the channel access procedure type from the second type (for instance an initially configured channel access type, e.g. type 1) to the first type (a different channel access procedure type, e.g. type 2A) when the sharing indication indicates that the COT is shared with the UE. That is, the UE may perform channel access procedure of a first type or channel access procedure of a second type based on the gNB COT sharing indication. Preferably, according to the present disclosure, the channel access procedure type is switched from type 1 to type 2A.

Therefore, the UE may also switch the LBT category from the first category (for instance an initially configured LBT category, e.g. Cat 4) to the second category (a different LBT category, e.g. Cat 2) when the sharing indication indicates that the COT is shared with the UE. That is, the UE may perform LBT procedure of a first category or LBT procedure of a second category based on the gNB COT sharing indication.

The LBT type switching may be enabled only for resources, in the time domain, comprised within the gNB COT time duration. For instance, it may be enabled for the resources comprised between the resources in which the DCI is received and the resource in which the gNB COT ends.

According to a variation of the first implementation, there may be a processing delay. The processing delay may correspond, for instance, to a given number of resources (i.e. symbols) with respect to the resources (i.e. symbols) in which the DCI is received. Within the processing delay the LBT type switching may not be effective (that is, it may not be enabled) even after the DCI has been received. For example, and with further reference to FIG. 2, the PUSCH0 may not be considered for LBT type switching even if the gNB COT sharing is allowed. In other words, UE0, corresponding to PUSCH0 will not be allowed to perform the LNB type switch. This is because the PUSCH0 resources are after the resources in which the DCI is received but are within the resources associated with the processing delay. The exact value of processing delay may for instance be pre-defined in specifications. If a processing delay is present, the LBT type may be switched from the second type (for instance Cat 4) to the first type (for instance Cat 2) based on a sub-interval of the COT rather than based on the whole COT duration. The sub-interval takes into account the processing delay. For instance, the sub-interval of the COT may be defined as the COT duration minus the processing delay, that is, the time portion comprised between the processing delay end and the COT end shown in FIG. 2. In case the processing delay is present the type switching may be performed only if the resources for PUSCH transmission are comprised in the sub-interval. That is, they are comprised between the last resources in which the processing delay occurs and the resource in which the gNB's COT ends. In other words, the type switching is not performed in a time period, defined by the processing delay and starting after the DCI format 2_0 is received.

With further reference to FIG. 2, the resources of PUSCH4 are outside the gNB's COT (i.e. after the resource in which COT ends). Therefore, PUSCH4 will also not be considered for LBT type switching. In other words, UE4, corresponding to PUSCH4 will not be allowed to perform the LBT type switch.

The resources allocated to PUSCH1, PUSCH2 and PUSCH3 are after the last resource in which the processing delay occurs and before the resource after which the gNB's COT ends. That is, they are within the COT sub-interval. Therefore, PUSCH1, PUSCH2 and PUSCH3 are allowed to share the gNB's COT if gNB COT sharing is enabled. In other words, UE1, UE2 and UE3 corresponding to PUSCH1, PUSCH2 and PUSCH3 respectively are allowed to perform the LNB type switch. Then for these PUSCH transmissions, the LBT type can be switched. That is, PUSCH1, PUSCH2 and PUSCH3 can be transmitted by switching the LBT category provided the sharing indication indicates that the gNB's COT is shared with the UE.

Further details regarding LBT switching are discussed in connection with the other implementations of the present disclosure described below.

According to a sub-implementation of the first implementation, the second type channel access procedure (i.e. type 1 or Cat 4) may comprise a random sensing duration and the random sensing duration may be relevant for a channel access priority class. The priority class may be a parameter indicative of a set of parameters used for performing the channel access procedure, as for instance the contention windows CW used in the LBT procedure. Moreover, if the UL transmissions are PUSCH transmissions on configured resources, the UE may assume any priority class for the channel occupancy shared with the gNB.

According to a sub-implementation the uplink transmission is not limited to PUSCH transmission and the uplink transmission may for instance comprise at least one of: PUSCH transmission, PUCCH transmission, SRS transmission, PRACH transmission.

[Second Implementation]

According to the second implementation the LBT switching can be performed using pre-defined settings. Here pre-defined means for instance that the settings have been defined at a time point prior to the time point at which the DCI format 2_0 is received by the UE. In other words, these settings are available to the UE prior to the reception of the DCI format 2_0 in the time slot n. The second implementation may have the advantage that the overhead of the DCI signaling is low. LBT settings such as the LBT type, the LBT starting point, the cyclic prefix extension, ECP, length, the gap indication, and/or other parameters can be pre-defined and does not need to be signaled in DCI format 2_0.

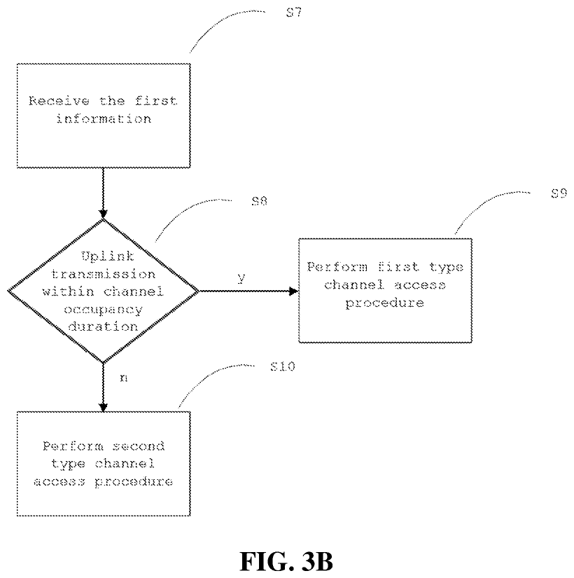

According to the second implementation there may be different sets of pre-defined settings for performing LBT. For instance, there may be at least two sets of pre-defined settings: a first set of settings for PUSCH transmission whose resources in time domain are right after downlink symbols and a second set of settings for PUSCH transmission whose resources in time domain are right after an uplink symbol (or after an uplink symbol). In this connection, right after downlink symbols means that between the time resources for PUSCH transmission and the downlink symbol there are no uplink symbols. For instance, between the resource in time for PUSCH transmission and the downlink symbols there are only flexible symbols in time domain and no uplink symbols as exemplarily shown in FIG. 4. In other words, the symbol immediately preceding in the time domain the first symbol allocated for PUSCH transmission is not an uplink symbol. Moreover, in this connection, right after an uplink symbol means that the symbol immediately preceding in the time domain the uplink symbol for PUSCH transmission is an uplink symbol.

Moreover, it is to be noted that the first set of settings may comprise more than one set of settings. Similarly, also the second set of settings may comprise more than one set of setting. For instance, there may be different set of first settings and different set of second settings based on different SCS values as explained later on.

FIG. 4 schematically illustrates a first set of LBT settings of an LBT scheme according to the second implementation of the present disclosure. In the example shown in FIG. 2, PUSCH1 and PUSCH2 are located right after downlink symbols. PUSCH3 is located after an uplink symbol. In this case, PUSCH1 and PUSCH2 may use a set of settings different from the set of settings used for PUSCH3. That is, PUSCH1 and PUSCH2 may be performed using the first set of settings whereas PUSCH 3 may be performed using the second set of settings. For PUSCH1 and PUSCH2 since the PUSCH resources are located after the downlink symbols, the LBT starting position can be at the symbol edge before the PUSCH resources. For PUSCH1 and PUSCH2, the LBT starting position can be at the edge of the flexible symbol prior to the first symbol of PUSCH1 and PUSCH2 resource. That is the LBT start can be at the edge of the first flexible symbol and the second flexible symbol as shown in FIG. 4.

With further reference to FIG. 4 and according to a specific, non-limiting example, the ECP length may be equal to 1 symbol length minus gap minus timing advance, TA, (i.e. 1 symbol length-gap-TA). According to this example, the gap duration may be 16 us or 25 us. This setting may be suitable for 15khz and 30khz subcarrier spacing, SCS, system where ECP length=1 symbol length-gap-TA, is not a negative value. Here, as it is known, TA takes into account the fact that a signal transmitted from a UE takes a certain time length to reach a BS. For instance, of 15 khz SCS, the symbol length is around 71.4us, for gap=25 us and TA=9 us, the ECP length is always positive. For 30 khz SCS, the symbol length is around 35.7 us, thus the ECP length is also positive. The LBT type (or LBT category) in this case may be type 2C (or Cat 1) or type 2A or 2B (or Cat2). The selection of type 2C (Cat 1) can be set for the first PUSCH transmission, i.e. PUSCH1 in the example of FIG.1.

Moreover, for instance, since PUSCHI is transmitted by UE1 by performing Cat 1, PUSCH2 may be transmitted by UE2 using Cat 2. That is UE2 may switch the LBT type from the second type (i.e. cat 4 or type 1) to a first type (i.e. Cat 2 or type 2A and 2B) within the gNB's COT to transmit PUSCH2, not only based on the first information but also based on a third channel access procedure type (i.e. Cat 1 or type 2C) of UE1.

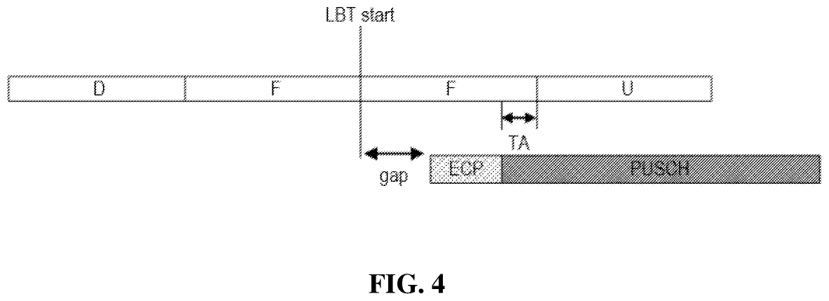

According to another specific, non-limiting example, the SCS may be equal to 60 khz, the LBT starting positions of PUSCHI and PUSCH2 may be at the edge symbol, which is two flexible symbols ahead of the first symbol of PUSCHI and PUSCH2. This is because the symbol length is around 17.9 us, thus for gap duration (also called sensing duration) of 25 us or of 16 us and TA=9 us, the ECP length based on 1 symbol length is not enough. Therefore, the LBT starting position should be placed two symbols ahead of the first symbol of the scheduled PUSCH as shown in FIG. 5. In particular, FIG. 5 schematically illustrates another set of LBT settings of an LBT scheme according to the second implementation of the present disclosure.

The settings described in connection with FIG. 4 and FIG. 5, can be both referred to as downlink, flexible to uplink DFU setting. They can also be referred to as the first set of settings. Both first set of settings have in common the fact that the symbol before resources in which the uplink signal or the uplink channel is transmitted in time domain is a flexible symbol.

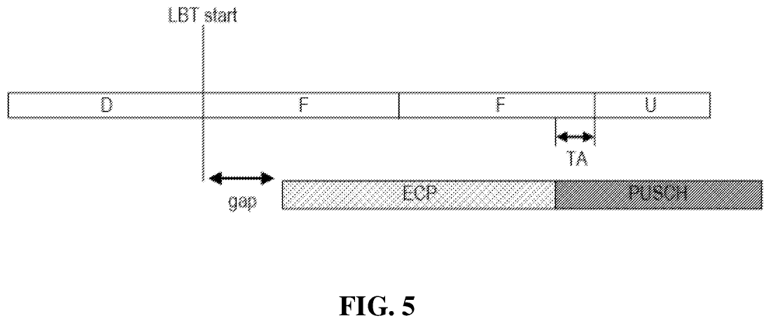

The pre-defined LBT settings for transmitting PUSCH3 are different from that of PUSCHI and PUSCH2. This is because, as can be seen from FIG. 2, there are uplink symbols in time domain prior to the uplink symbols allocated for PUSCH3. The presence of an uplink symbol implies that before PUSCH3, there might be uplink transmissions. Thus, for PUSCH3, the LBT starting position can be at the previous symbol edge with an offset of TA. Here the previous symbol may be the last symbol in which PUSCH2 of FIG. 1 is transmitted. In other words, the previous symbol is the symbol immediately before the first symbol in which PUSCH3 is transmitted. This configuration is schematically illustrated in FIG. 6. The reason of having this TA offset for LBT starting position is that the previous symbols might be allocated for uplink transmission for other UEs, that will transmit the uplink transmission with TA. This means that the transmission won't last until the end of the uplink symbol but will end earlier. In order to maintain a required gap duration, the LBT should be started earlier by an offset of TA as well. The ECP length with this setting will become ECP length=1 symbol length−gap. The gap duration can be 16 us or 25 us.

This setting may be referred to as uplink to uplink, UU, setting or second set of settings. The second set of setting is used since the symbol before resources in which the uplink signal or the uplink channel is transmitted in time domain is an uplink symbol.

Moreover, to keep the ECP length a positive value, for SCS=60 khz, the LBT starting position should be two symbols before the first symbol of scheduled PUSCH3. Similar to the description provided above for FIG. 5, employing a different SCS results in another example of second set of settings.

It is to be noted that the first set of settings and the second set of settings can be pre-defined. As long as the UE obtains the SFI and COT duration, the UE will know which set of settings should be applied. Moreover, as long as the UE knowns the SCS the UE will also know which settings of the first set of settings (or of the second set of settings) should be applied.

[Third Implementation]

According to the third implementation the gNB may control the switching settings (that is the first set of setting and the second set of settings) dynamically.

According to the second implementation, the gNB does not indicate to the UE which set of LBT settings the UE should use. In the second implementation rather, the UE may derive the set of settings based on the SFI, COT indication and processing delay. Moreover, different set settings may be applicable based on the SCS.

However, the LBT set of settings (including, LBT type, gap duration, LBT starting position, and/or ECP length) can be indicated directly in DCI format 2_0 by the gNB. Since the DCI format 2_0 is a group-common PDCCH, the indicated LBT set of setting might not be applicable for each UE of UE0 to UE4 but may be applicable only for a subset thereof.

Therefore, according to a first aspect of the third implementation the LBT set of settings indicated in the DCI format 2_0 is applicable only to one of the PUSCHs. For instance, it may be applicable only to the first slot PUSCH (i.e. the PUSCH transmitted in the first slot) after the processing delay end. In other words, it may be applicable only for the PUSCH scheduled after the processing delay. That is, with reference to FIG. 1, it may be applicable only to PUSCH 1, but not to PUSCH2 to PUSCH4. In this case, for instance, UE2 to UE4 may still derive the set of settings to use for transmitting PUSCH2 to PUSCH4 as described in connection with the second implementation. One of the advantages of the first aspect of the third implementation is that the gNB can have more control of the PUSCH LBT switching setting in comparison with the LBT switching of the second implementation while also containing DCI overhead.

According to a second aspect of the third implementation the gNB may indicate the LBT set of settings for each of the slots. That is, the gNB may indicate the first set of setting or the second set of setting to each UE.

Then the UE that are scheduled in different slots will follow the LBT setting of settings of the scheduled slot. The advantage of the method is that the gNB can have full control of the PUSCH LBT switching setting for each of the slot, even though it requires an overhead higher in DCI format 2_0 than that of the second implementation or higher than that of the first aspect of the third implementation.

[Fourth Implementation]

According to the fourth implementation, the gNB may send an additional sharing indication in DCI format 2_0. The additional sharing indication may indicate whether the gNB's COT will be regained back by the gNB itself after the COT has been shared with the UE. That is the additional sharing indication may inform the UE of a time period in which the gNB's COT is not anymore shared by the gNB. For instance, the additional sharing indication may indicate a resource after which the COT is not anymore shared. Similarly, the additional sharing indication may indicate that the COT is only shared once with the UE. Alternatively, the additional sharing indication may indicate that the COT will not be regained back by the gNB.

The additional sharing information may be particularly advantageous in combination with the UU setting. For example, if the gNB indicates that the COT won't be obtained back by the gNB then the UU setting can use LBT starting position at the edge of the symbols without offset of TA. The fact that the COT is not obtained back by the gNB means that the COT will always be used for uplink transmission after it is firstly shared by the earliest PUSCH.

Therefore, for UU setting, whether or not the offset TA is needed for LBT starting position will depend on whether or not the gNB will get the COT back after the COT is shared with PUSCH.

[Additional Implementations]

According to an aspect of the disclosure the first information further includes a sharing indication, indicating whether the COT is shared with the UE and the method comprises the following two steps. Step 1: switching the LBT type, by the UE, from the second type to the first type when the sharing indication indicates that the COT is shared with the UE, and based on the COT or on a sub interval thereof. Step 2: performing the LBT of the first type, by the UE, within the COT to transmit an uplink signal or the uplink channel within the COT.

According to another aspect of the disclosure the first information includes a slot format indicator, SFI, and the LBT of the first type is performed according to a set of settings determined based on the information element.

According to another aspect of the disclosure the method further comprises deriving, by the UE, the set of settings based on the first information.

According to another aspect of the disclosure the LBT of the first type is performed on the basis of a pre-defined set of settings.

According to another aspect of the disclosure the LBT of the first type is performed on the basis of a set of settings included in the first information.

According to another aspect of the disclosure the set of settings includes at least one of: an extended cyclic prefix length; an indication of a gap; an LBT starting point; an LBT category.

According to another aspect of the disclosure the set of settings of the LBT of the first type comprises a first set of settings and a second set of settings, wherein the UE performs the LBT of the first type using the first set of settings or using the second set of settings based on a type of a symbol before resources in which the uplink signal or the uplink channel is transmitted in time domain.

According to another aspect of the disclosure the uplink signal or the uplink channel is a PUSCH and the UE performs the LBT of the first type using the first set of settings when the symbol before resources in which the uplink signal or the uplink channel transmitted in time domain is a flexible symbol and the UE performs the LBT of the first type using the second set of settings when the symbol before the resources in which the uplink signal or the uplink channel is transmitted in time domain is an uplink symbol.

According to another aspect of the disclosure the LBT of the second type is a Cat 4 LBT and the LBT of the first type is a Cat 1 LBT or a Cat 2 LBT. The method further comprising the steps of: Step 1 scheduling, by the BS, resources in time domain to the UE to transmit the PUSCH and use Cat4 LBT; Step 2 receiving, by the UE, before the scheduled resources in time domain, the first information, Step 3 switching, by the UE, from Cat4 LBT to Catl or Cat2 LBT based on the first information.

According to another aspect of the disclosure wherein the UE is referred hereinafter as the first UE and the uplink signal or the uplink channel is referred hereinafter as the first uplink signal and wherein the system includes a second UE scheduled to transmit a second uplink signal, performing LBT of the second type, at a second time, wherein the second time is different from a first time at which the first UE is scheduled to transmit the first uplink signal. The method comprising the steps of: Step 1 sending, by the BS, a common information element to the first UE and to the second UE; Step 2 switching, by the second UE, the LBT type, from the second type to a third type within the COT to transmit the second uplink signal within the COT, based on the information element and based on the second LBT type of the first UE.

According to another aspect of the disclosure the second time is after the first time.

According to another aspect of the disclosure one of the LBT of the first type and the LBT of the third type is performed on the basis of a pre-defined set of settings and wherein the other one of the LBT of the first type and the LBT of the third type is performed on the basis of a set of settings included in the information element.

According to another aspect of the disclosure the first information further includes an additional sharing indication indicative of a time period in which the COT is shared with the UE.

[Configuration of the Base Station]

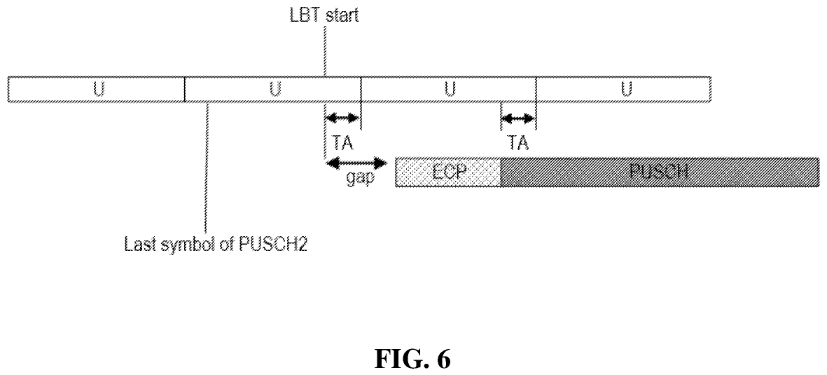

FIG. 7 shows an exemplary configuration for a base station 100. The base station may be the gNB described in connection with the implementations of the present disclosure. The base station 100 may comprise a memory 110 and a processor 120. The processor may be for instance processing circuitry which may comprise a controller. The memory may be connected to the processor. Any module of the base station 100, e.g. a communication module, may be implemented in and/or executable by, the processor 120, in particular as module in the controller.

The base station 100 may also comprise a transmitter 130. The transmitter 130 may be a radio circuitry and may provide receiving and transmitting or transceiving functionality, e.g. one or more transmitters and/or receivers and/or transceivers, wherein the radio circuitry is connected or connectable to the processor 120. An antenna (not shown), which may be an antenna circuitry of the base station 100 may be connected or connectable to the radio circuitry to collect or send and/or amplify signals. The base station 100 may be adapted to carry out the steps of the method for performing the channel access operation described above in connection with the bases station; in particular, it may comprise corresponding circuitry, e.g. processing circuitry, and/or modules.

[Configuration of the Terminal]

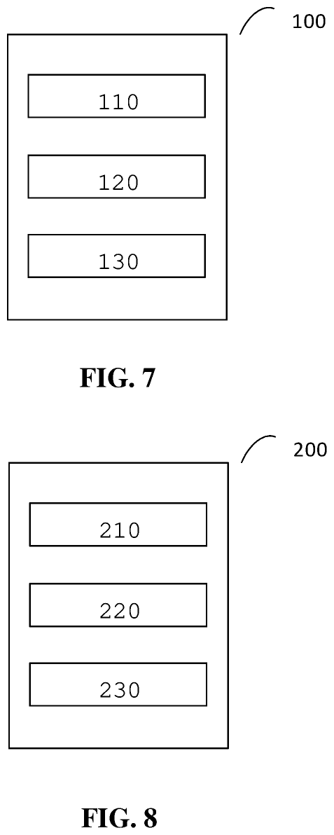

FIG. 8 shows an exemplary configuration for an UE 200. The UE 200 represent the configuration of any of UE0 to UE4 refereed in connection with the implementations of the present disclosure. The UE may comprise a memory 210 and a processor 220. The processor 220 may be for instnace a processing circuitry which may comprise a controller. The memory may be connected to the processor. Any module of the UE, e.g. a communication module or determining module, may be implemented in and/or executable by, the processing circuitry, in particular as module in the controller. The UE 200 may also comprise a transmitter 230. The transmitter 230 may be a radio circuitry and may provide receiving and transmitting or transceiving functionality, e.g. one or more transmitters and/or receivers and/or transceivers, wherein the radio circuitry is connected or connectable to the processor 220. An antenna (not shown), which may be an antenna circuitry of the UE 200 may be connected or connectable to the radio circuitry to collect or send and/or amplify signals. The UE 200 may be adapted to carry out the steps of the method for performing the channel access procedure described above in connection with the UE; in particular, it may comprise corresponding circuitry, e.g. processing circuitry, and/or modules.

[Wireless Communication Network]

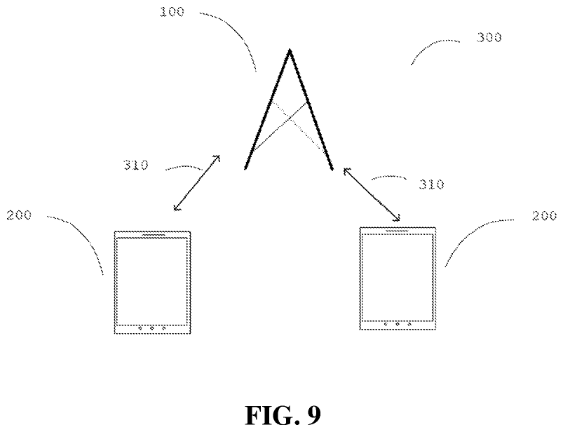

FIG. 9 shows an example of a wireless communication network 300 comprising a network node, i.e. the base station 100, a first UE 200, and a second UE 200. While FIG. 9 shows one network node and two UEs this is not limiting and the wireless communication network 300 may comprise a different number of network nodes and UEs. In the wireless communication network the base station 100 is able to send any kind of downlink data to the UEs 200 via communication link 310 and the UEs 200 are able to send any kind of uplink data to the base station 100 via communication link 310.

There is also generally considered a computer program product comprising instructions adapted for causing processing and/or control circuitry to carry out and/or control any method described herein, in particular when executed on the processing and/or control circuitry. Also, there is considered a carrier medium arrangement carrying and/or storing a computer program product as described herein.

A carrier medium arrangement may comprise one or more carrier media. Generally, a carrier medium may be accessible and/or readable and/or receivable by processing or control circuitry. Storing data and/or a computer program product and/or code may be seen as part of carrying data and/or a program product and/or code. A carrier medium generally may comprise a guiding or transporting medium and/or a storage medium. A guiding or transporting medium may be adapted to carry and/or store signals, in particular electromagnetic signals and/or electric signals and/or magnetic signals and/or optical signals. A carrier medium, in particular a guiding or transporting medium, may be adapted to guide such signals to carry them. A carrier medium, in particular a guiding or transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

Although the present disclosure has been described on the basis of detailed examples, the detailed examples only serve to provide the skilled person with a better understanding, and are not intended to limit the scope of the disclosure. The scope of the disclosure is much rather defined by the appended claims.

TS 37.213 Section 4.2.1.1 Type 1 UL Channel Access Procedure

This clause describes channel access procedures by a UE where the time duration spanned by the sensing slots that are sensed to be idle before a UL transmission(s) is random. The clause is applicable to the following transmissions:

PUSCH/SRS transmission(s) scheduled or configured by eNB/gNB, or

PUCCH transmission(s) scheduled or configured by gNB, or

Transmission(s) related to random access procedure.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.

1) set N=Nᵢₙᵢₜ, where Nᵢₙᵢₜ is a random number uniformly distributed between 0 and CWₚ, and go to step 4;

2) if N>0 and the UE chooses to decrement the counter, set N=N−1;

3) sense the channel for an additional slot duration, and if the additional slot duration is idle, go to step 4; else, go to step 5;

4) if N=0, stop; else, go to step 2.

5) sense the channel until either a busy slot is detected within an additional defer duration Td or all the slots of the additional defer duration T_{d} are detected to be idle;

6) if the channel is sensed to be idle during all the slot durations of the additional defer duration T_{d}, go to step 4; else, go to step 5;

If a UE has not transmitted a UL transmission on a channel on which UL transmission(s) are performed after step 4 in the procedure above, the UE may transmit a transmission on the channel, if the channel is sensed to be idle at least in a sensing slot duration T_{d} when the UE is ready to transmit the transmission and if the channel has been sensed to be idle during all the slot durations of a defer duration T_{d} immediately before the transmission. If the channel has not been sensed to be idle in a sensing slot duration T_{d} when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 us immediately followed by mₚ consecutive slot durations where each slot duration is Tₛₗ=9 us, and T_{f} includes an idle slot duration T_{d} at start of T_{f}.

CW_{min,p}≤CWₚ≤CW_{max,p} is the contention window. CWₚ adjustment is described in clause 4.2.2.

CW_{min,p} and CW_{max,p} are chosen before step 1 of the procedure above.

mₚ, CW_{min,p}, CW_{max,p} are based on a channel access priority class as shown in Table 4.2.1-1, that is signaled to the UE.

TS 37.213 Section 4.2.1.2 Type 2 UL Channel Access Procedure

This clause describes channel access procedures by UE where the time duration spanned by the sensing slots that are sensed to be idle before a UL transmission(s) is deterministic.

If a UE is indicated by an eNB to perform Type 2 UL channel access procedures, the UE follows the procedures described in clause 4.2.1.2.1.

TS 37.213 Section 4.2.1.2.1 Type 2A UL Channel Access Procedure

If a UE is indicated to perform Type 2A UL channel access procedures, the UE uses Type 2A UL channel access procedures for a UL transmission. The UE may transmit the transmission immediately after sensing the channel to be idle for at least a sensing interval T_{short_u1}=25 us. T_{short_u1} consists of a duration T_{f}=16 us immediately followed by one slot sensing slot and T_{f} includes a sensing slot at start of T_{f}. The channel is considered to be idle for T_{short_u1} if both sensing slots of T _{short_u1} are sensed to be idle.

TS 37.213 Section 4.2.1.2.2 Type 2B UL Channel Access Procedure

If a UE is indicated to perform Type 2B UL channel access procedures, the UE uses Type 2B UL channel access procedure for a UL transmission. The UE may transmit the transmission immediately after sensing the channel to be idle within a duration of T_{f}=16 us. T_{f} includes a sensing slot that occurs within the last Sus of T_{f}. The channel is considered to be idle within the duration T_{f} if the channel is sensed to be idle for total of at least 5 us with at least 4us of sensing occurring in the sensing slot.

4.2.1.2.3 Type 2C UL Channel Access Procedure

If a UE is indicated to perform Type 2C UL channel access procedures for a UL transmission, the UE does not sense the channel before the transmission. The duration of the corresponding UL transmission is at most 584 us.

1. Method for performing channel access procedure, in a communication system comprising a terminal, UE, and a base station, BS, communicating in a shared spectrum, the method comprising the steps of:
sending, by a BS to a UE, a first information including information indicative of channel occupancy time, COT, of the BS;
performing, by the UE, channel access procedure of a first type or channel access procedure of a second type, based on at least the first information, to perform an uplink transmission.

2. Method for performing channel access procedure according to claim 1, wherein the UE receives the first information before performing the uplink transmission.

3. Method for performing channel access procedure according to claim 1, wherein the channel access procedure of the second type is determined for the uplink transmission before receiving the first information.

4. Method for performing channel access procedure according to claim 1, wherein the UE receives a DCI format 2_0 from the BS, wherein the DCI format 2_0 comprises the first information.

5. Method for performing channel access procedure according to claim 1, wherein the first information comprises a channel occupancy duration.

6. Method for performing channel access procedure according to claim 5, wherein the UE determines a channel occupancy end from the channel occupancy duration and a location of the DCI format 2_0.

7. Method for performing channel access procedure according to claim 1, wherein the UE performs the first type channel access procedure when the uplink transmission is within the channel occupancy duration.

8. Method for performing channel access procedure according to claim 1, wherein the first type channel access procedure comprises at least a type 2A channel access procedure.

9. Method for performing channel access procedure according to claim 8, wherein the type 2A channel access procedure comprises a deterministic sensing duration of 25 microseconds.

10. Method for performing channel access procedure according to claim 1, wherein the second type channel access procedure comprises at least a type 1 channel access procedure.

11. Method for performing channel access procedure according to claim 10, wherein the type 1 channel access procedure comprises a random sensing duration, wherein the random sensing duration is relevant to a channel access priority class.

12. Method for performing channel access procedure according to claim 1, wherein the UE performs the second type channel access procedure when the uplink transmission is not within the channel occupancy duration.

13. Method for performing channel access procedure according to claim 1, wherein the uplink transmission comprises at least one of the followings: PUSCH transmission, PUCCH transmission, SRS transmission, PRACH transmission.

14. A base station, BS, comprising:
a transmitter configured to send to a terminal, UE, a first information including information indicative of channel occupancy time, COT, of the BS; to allow the UE to perform a channel access procedure of a first type or a channel access procedure a second type based on at least the first information.

15. A terminal comprising:
a receiver configured to receive, from a base station, BS, a first information including information indicative of channel occupancy time, COT, of the BS;
a transmitter configured to transmit an uplink signal or an uplink channel by performing a channel access procedure of a first type or a channel access procedure of a second type based at least on the first information.

16. The terminal according to claim 15, wherein the receiver receives the first information before performing the uplink transmission.

17. The terminal according to claim 15, wherein the channel access procedure of the second type is determined for the uplink transmission before receiving the first information.

18. The terminal according to claim 15, wherein the receiver receives a DCI format 2_0 from the BS, wherein the DCI format 2_0 comprises the first information.

19. The terminal according to claim 15, wherein the first information comprises a channel occupancy duration.

20. The terminal according to claim 19, wherein the terminal determines a channel occupancy end from the channel occupancy duration and a location of the DCI format 2_0.
